(19) United States
(12) Patent Application Publication
(10) Pub. No.: US 2024/0288196 A1
(43) Pub. Date: Aug. 29, 2024

(54) A DUCT COUPLING ARRANGEMENT AND ASSOCIATED METHOD

(71) Applicant: Luca Turnbull, Double Bay (AU)

(72) Inventor: Luca Turnbull, Double Bay (AU)

(21) Appl. No.: 18/569,146

(22) PCT Filed: Jun. 10, 2022
(86) PCT No.: PCT/AU2022/050574

§ 371 Date: Dec. 11, 2023

(30) Foreign Application Priority Data
Jun. 11, 2021 (AU) 2021901760

(51) Int. Cl. F24F 13/02; F16L 59/18

(52) U.S. Cl. CPC F24F 13/0209; F16L 59/187; F16L 59/188

(57) ABSTRACT

An embodiment of the duct coupling arrangement 1 includes a first coupling member 2 that is configured for axial connection to a first length of ducting 3. The first coupling member 2 defines a male coupling formation. A second coupling member 9 is also configured for axial connection to a length of ducting, the second coupling member defining a female coupling formation. The male coupling formation and the female coupling formation are configured to make an interference fit with each other so as to toollessly axially couple to, and de-couple from, each other.

### TECHNICAL FIELD

The present invention relates to arrangements and associated methods for the connection of lengths of insulating duct to, for example, air conditioning fittings, other lengths of insulating duct, etc. Embodiments of the present invention find application, though not exclusively, in the installation and/or repair of central air conditioning systems into buildings such as homes, commercial establishments, warehouses, etc.

### BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The installation and/or repair of central air conditioning systems typically requires ducting to be installed within a roof cavity. This often takes place within a difficult work environment due to issues such as poor access, confined and/or awkward space, excessive heat and/or dust and the like.

Prior art installation methods typically involve cutting and joining lengths of ducting. The ducting typically consists of an outer foil layer, an intermediate insulating layer (often an insulating wool material) and an inner foil layer having a spirally wound wire extending therethrough. To cut a length of ducting, the installer would typically make use of a sharp blade to initially pierce one side of the cylindrical ducting through the outer foil layer, the insulating layer and the inner foil layer. The blade is then used to saw around the circumference of the ducting until the only remaining connection is the spirally wound wire. A cutting implement, such as a pair of wire cutters, is then used to cut the spirally wound wire and thereby complete the cutting of the length of duct into two separate sections.

A typical prior art arrangement for the joining of two lengths of ducting makes use of a cylindrical duct joiner, which is simply a piece of metal sheet in the form of a hollow cylindrical length to which a first length of ducting is joined at one end and a second length of ducting is joined at the opposite end. More particularly, to join a length of ducting to a cylindrical duct joiner, the first step of this prior art process involves attaching the inner foil layer, which is pulled out of the ducting and fitted over one end of the cylindrical duct joiner. A length of zip tie is then tightened over the inner foil layer to secure it to the cylindrical duct joiner. Alternatively, a length of adhesive tape may be wound around the inner foil layer to secure it to the cylindrical duct joiner. The second step of this prior art process involves attaching the intermediate insulating layer and the outer foil layer of the ducting to the cylindrical duct joiner. These parts of the ducting are pulled towards the portion of the inner foil layer that was secured to the cylindrical duct joiner in the first step. Adhesive tape is then wound around the outer foil layer so as to compress the outer foil layer and the intermediate insulating layer radially towards the cylindrical duct joiner.

The two step joining process described in the preceding paragraph will often take an experienced installer 3 to 6 minutes to complete. To install a central air conditioning system into a typical residential house may require approximately 30 to 80 such joints to be formed. Hence, the time required to form these joints can represent a substantial proportion of the total time required to install an air conditioning system.

Another issue associated with the above-described joining process is that short cuts can be taken, such as omitting the first step of securing the inner foil layer to the cylindrical duct joiner. Such an omission is typically obscured by the outer foil layer and the intermediate insulating layer. Hence, once the installation has been completed, such an omission can be difficult or impossible for a casual observer to notice, which increases the temptation for unscrupulous installers to take such short cuts.

These joints are often made in such a manner that a gap is formed between the insulation of the first length of ducting and the insulation of the second length of ducting. This uninsulated gap undesirably allows heat to move into or out of the ducting, which impairs the thermal efficiency of the air conditioning system. For example, if cool air-conditioned air is flowing through the ducting, heat can readily pass through the uninsulated gap and the metal joiner and thereby undesirably heat up the air-conditioned air contained within the ducting.

### SUMMARY OF THE INVENTION

It is an object of the present invention to overcome, or substantially ameliorate, one or more of the disadvantages of the prior art, or to provide a useful alternative.

In one aspect of the present invention there is provided a duct coupling arrangement including: a first coupling member being configured for axial connection to a length of ducting, the first coupling member defining a male coupling formation; and a second coupling member being configured for axial connection to a length of ducting, the second coupling member defining a female coupling formation; wherein the male coupling formation and the female coupling formation are configured to make an interference fit with each other so as to toollessly axially couple to and de-couple from each other.

In one embodiment the male coupling formation includes at least one circumferentially extending, radially outwardly projecting rib and the female coupling formation includes at least one circumferentially extending, radially inwardly projecting rib and an outer radius of the at least one outwardly projecting rib is slightly greater than an inner radius of the at least one inwardly projecting rib so as to provide said interference fit.

In another embodiment the male coupling formation includes at least one circumferentially extending, radially outwardly projecting rib and the female coupling formation includes a plurality of resiliently deformable radially inwardly extending projections.

In yet another embodiment the female coupling formation includes at least one circumferentially extending, radially inwardly projecting rib and the male coupling formation includes a plurality of resiliently deformable radially outwardly extending projections.

Preferably each of the plurality of projections has a radial height of between approximately 0.3 mm and 6 mm.

Preferably the at least one rib has a radial height of between approximately 0.3 mm and 6 mm.

In an embodiment the ducting includes an inner layer and the first coupling member and the second coupling member each include an axially extending hollow cylindrical member sized to be received into said inner layer. Preferably an adhesive adheres the inner layer to the hollow cylindrical member.

In an embodiment the ducting includes an outer layer and the first coupling member and the second coupling member each include an axially extending outer hollow cylindrical member sized to receive said outer layer. Preferably an adhesive adheres the outer layer to the outer hollow cylindrical member.

Preferably the female coupling formation includes a cylindrical member sized to receive the male coupling formation.

Preferably the first coupling member and the second coupling member each include a central aperture positioned in axial alignment with an inner gas flow path defined by the ducting.

Preferably thermal insulation is disposed radially inwardly of the male coupling formation.

In an embodiment the first coupling member and the second coupling member are each formed from a plastics material.

In an embodiment the duct coupling arrangement is configured to connect to a support bracket. In this embodiment a connection fitting is disposed on a radially outer surface of the first coupling member and/or the second coupling member, the connection fitting being configured to connect to a support bracket.

Preferably coupling of the first coupling member with the second coupling member forms a substantially air-tight seal.

In a second aspect of the present invention there is provided a length of ducting extending between a first end and a second end, the length of ducting including: a first coupling member being disposed at the first end, the first coupling member defining a male coupling formation configured to make an interference fit with a complementary female coupling formation of a like length of ducting so as to couple the length of ducting to the like ducting; and a second coupling member being disposed at the second end, the second coupling member defining a female coupling formation configured to make an interference fit with a complementary male coupling formation of a like length of ducting so as to couple the length of ducting to the like ducting.

Preferably the length extending between the first end and the second end is selected from a plurality of pre-defined lengths, which in one embodiment are any two or more of: approximately 500 mm; approximately 1 m; approximately 2 m; approximately 3 m; approximately 4 m; approximately 5 m; and approximately 6 m.

Preferably the length of ducting is packageable in an axially compressed state.

In another aspect of the present invention there is provided a method of installing air conditioning ducting including: providing a plurality of lengths of ducting, each being as described above; and coupling said lengths of ducting to each other so as to form an air-conditioning ducting system.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a perspective view of a first length of ducting terminating in a first coupling member according to a first embodiment of the invention and a second length of ducting terminating in a second coupling member according to the first embodiment of the invention, with the first and second coupling members being in a de-coupled state;

FIG. 2 is a perspective view of the first and second lengths of ducting from FIG. 1 connected to each other by virtue of coupling of the first coupling member to the second coupling member;

FIG. 3 is a cross-sectional view of the first length of ducting from FIG. 1;

FIG. 4 is a cross-sectional view of the second length of ducting from FIG. 1;

FIG. 5 is a cross-sectional view of the first and second lengths of ducting from FIG. 1 with the coupling members in a coupled state;

FIG. 5A is a detail cross-sectional view of the rectangular portion of FIG. 5;

FIG. 6 is a is a perspective view of a first length of ducting terminating in a first coupling member according to a second embodiment of the invention and a second length of ducting terminating in a second coupling member according to the second embodiment of the invention, with the first and second coupling members being in a de-coupled state;

FIG. 7 is a perspective view of the first and second lengths of ducting from FIG. 6 connected to each other by virtue of coupling of the first coupling member to the second coupling member;

FIG. 8 is a cross-sectional view of the first length of ducting from FIG. 6;

FIG. 9 is a cross-sectional view of the second length of ducting from FIG. 6;

FIG. 10 is a cross-sectional view of the first and second lengths of ducting from FIG. 6 with the coupling members in a coupled state; and

FIG. 10A is a detail cross-sectional view of the rectangular portion of FIG. 10.

### DETAILED DESCRIPTION OF PREFERRED EMBODIMENTS OF THE INVENTION

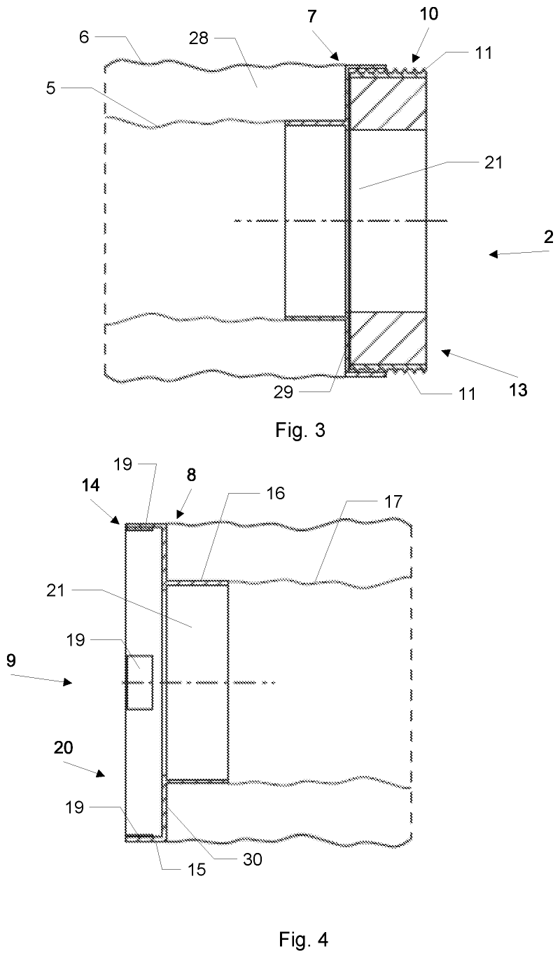

As best shown in FIGS. 1 to 5, a first embodiment of the duct coupling arrangement 1 includes a first coupling member 2 that is configured for axial connection to a first length of ducting 3. The duct-facing side 7 of the first coupling member 2 has an axially extending hollow cylindrical member 4 sized to be received into an inner layer 5 of the ducting 3. Either at the time of manufacture, or during installation, an adhesive is used to adhere the inner layer 5 to the hollow cylindrical member 4. Any suitable adhesive may be used to adhere the surfaces together, with the preferred embodiment making use of an aerated adhesive.

The duct-facing side 8 of the second coupling member 9 is also adhered to its respective length of ducting 12 in the fashion outlined above. That is, as best shown in FIG. 4, the second coupling member 9 also has an axially extending hollow cylindrical member 16 sized to be received into, and to be adhered to, the inner layer 17 of the second length of ducting 12.

Although not shown in the drawings, the duct-facing sides of some embodiments of the first and second coupling members 2, 9 also each include an axially extending outer hollow cylindrical member sized to receive an outer layer 6 of the ducting 3. This provides another pair of surfaces that can be adhered to each other so as to further increase the bond strength holding the ducting 3 to the duct-facing sides 7, 8 of the first and second coupling members 2, 9. Each of the outer hollow cylindrical members may include a distal lip that flares outwards to create a taper allowing for easier insertion of the ducting into the duct-facing sides 7, 8 of the coupling members 2, 9.

Another embodiment (not illustrated) makes use of a plurality of small hooks that are disposed on the duct-facing side of the hollow cylindrical members 4, 16. In some embodiments such hooks may also be disposed on the duct-facing side of the outer hollow cylindrical members. The hooks are angled inwardly to allow insertion of the ducting into the flanges, but to resist withdrawal of the ducting.

The first coupling member 2 and the second coupling member 9 each include a central aperture 21 positioned in axial alignment with the inner gas flow path that is defined by the inner layer 5 of the ducting 3, 12. This aperture 21 is formed by the radially inner side of the cylindrical members 4, 16. The aperture 21 is of a very similar size to the size of the inner layer 5 of the ducting 3, 12 and it is concentric therewith. Hence, in use, this arrangement causes minimal disturbance of the air flow through the coupling point of the two lengths of ducting 3, 12.

The coupling-facing side 13 of the first coupling member 2 defines a male coupling formation 10 having at least one, and in the preferred embodiment four, circumferentially extending, radially outwardly projecting ribs 11. The ribs 11 have a radial height of between approximately 0.3 mm and 6 mm and in the preferred embodiment the ribs 11 have a radial height of approx. 3 mm. As will be described in more detail below, these ribs 11 are involved in the formation of an interference fit between the first and second coupling members 2, 9.

The coupling-facing side 20 of the second coupling member 9 includes a female coupling formation 14 in the form of a cylindrical member 15 sized to receive the male coupling formation 10. Attached to the inside of the cylindrical member 15 in radially spaced apart locations are three groupings of resiliently deformable radially inwardly extending projections 19. Each of these projections 19 are similar to the hooks that are typically used in hook and loop fastening arrangements. Each of the projections has a radial height of between approximately 0.3 mm and 6 mm and in the preferred embodiment this radial height is approximately 3.5 mm.

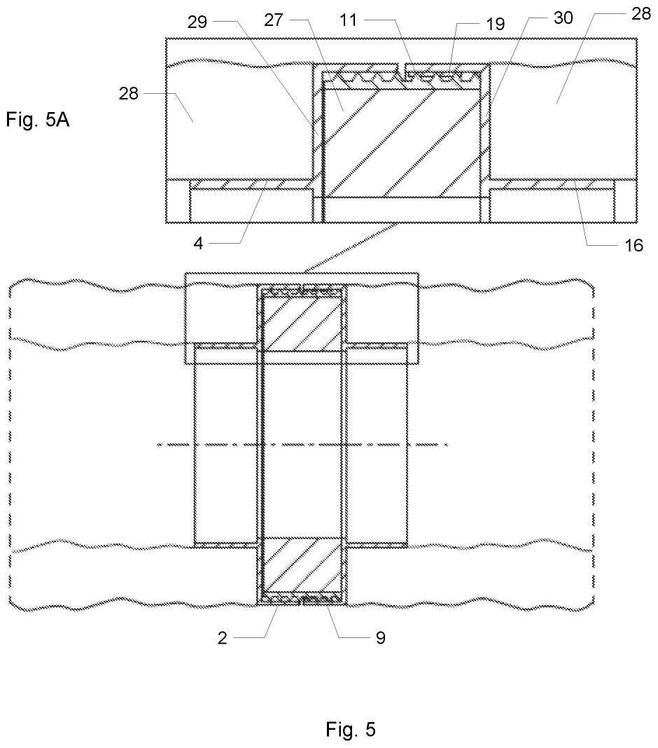

As can be best seen in the detail depiction provided by FIG. 5A, the maximum outer diameter of the ribs 11 on the male coupling formation 10 is small enough to be received into the cylindrical member 15 of the female coupling formation 14, but large enough to bend the projections 19 as the ribs 11 are being inserted. The resiliency of each of the projections 19 ensures that they spring back to their resting radially inwardly extending orientations after each rib 11 has passed by as the male coupling formation 10 is being inserted into the female coupling formation 14. Hence, the male coupling formation 10 and the female coupling formation 14 are configured to make an interference fit with each other. This allows the installer to toollessly axially couple and de-couple the first and second coupling members 2, 9. Advantageously, this means that the coupling occurs in a single step as opposed to the two-step prior art approach. This single-step coupling process typically takes approximately 10 to 20 seconds, which is substantially quicker than the two-step prior art connection method. Once fully inserted, the coupling of the first coupling member 2 with the second coupling member 9 preferably forms a substantially air-tight seal.

The tolerances between the ribs 11 and the projections 19, along with the total number of ribs 11, their deformability, the total number of projections 19 and their bending stiffness, are selected to provide the interference fit with coupling properties suitable for the intended usage. That is, the interference fit is engineered to be strong enough to maintain the coupling during normal operation of the air conditioning system. Additionally, the interference fit is preferably loose enough to allow an installer to couple the first and second coupling members 2, 9 without excessive effort. Also preferably, the interference fit is just loose enough to allow an installer to decouple the first and second coupling members 2, 9 for example by impacting the coupled arrangement against the installer's upper thigh.

In another embodiment (not illustrated), the positions and orientations of the groups of projections 19 and the ribs 11 are swapped. In this alternative embodiment, the female coupling formation includes the circumferentially extending ribs, however they project radially inwardly. Additionally, the male coupling formation includes the plurality of resiliently deformable projections, however they extend radially outwardly.

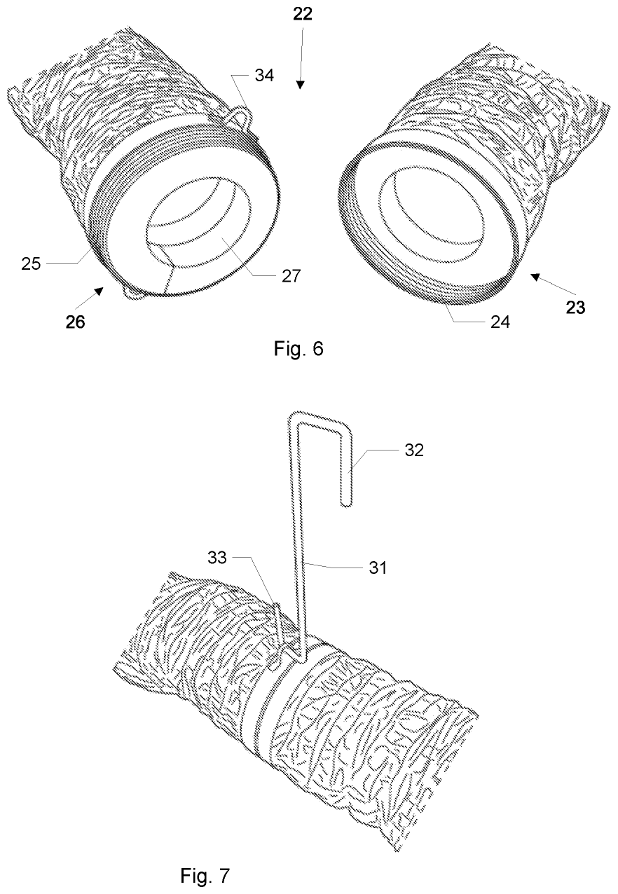

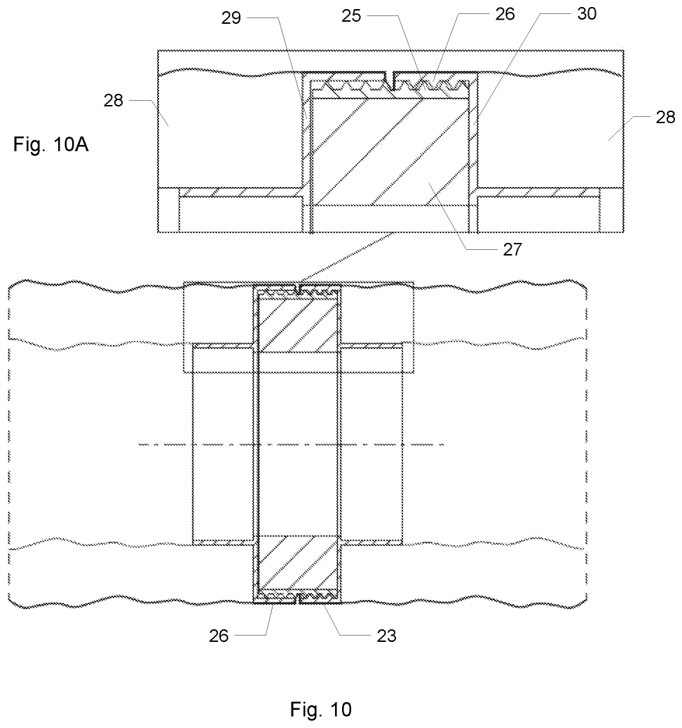

FIGS. 6 to 10 depict a second embodiment of the duct coupling arrangement 22 that is identical to the first embodiment with the exception of the type of interference fit being used to couple the first and second coupling members 35, 36. In particular, the variation of the second embodiment 22 relates mainly to the female coupling formation 23, which dispenses with the projections 19 and instead includes at least one, and in the illustrated embodiment four, circumferentially extending, radially inwardly projecting ribs 24 that are similar to the outwardly projecting ribs 25 on the male coupling formation 26. As can be best seen in the detail depiction provided by FIG. 10A, the outer radius of the outwardly projecting ribs 25 is slightly greater than the inner radius of the inwardly projecting ribs 24 and it is this small degree of overlap that provides the interference fit. That is, the ribs 24, 25 must deform as they push against each other as the male coupling formation 26 is being pushed into, or pulled out of, the female coupling formation 23. Hence, the ribs 24, 25 are formed from a material that is sufficiently deformable and/or compressible to allow the ribs 24, 25 to pass by each other despite their radially overlapping dimensions. Additionally, the material must be sufficiently resilient for the ribs 24, 25 to spring back to substantially their pre-deformation shapes such that the tips of ribs 24 can extend into the valleys between ribs 25. It is this meshing that holds the first and second coupling members 35, 36 together when the male coupling formation 26 has been fully inserted into the female coupling formation 23. Once fully inserted, the coupling of the first coupling member 35 with the second coupling member 36 preferably forms a substantially air-tight seal.

In both the first illustrated embodiment 1 and the second illustrated embodiment 22 a thermally insulative material 27, for example insulating wool or foam, is disposed radially inwardly of the male coupling formation 10, 26. As can be best seen in FIGS. 5A and 10A, this substantially mirrors the positioning of the insulating wool in the intermedial layer 28 of the ducting. Hence, when the coupling arrangement 1, 22 is coupled, there is a substantially continuous length of thermally insulative material in the form of either the insulating wool in the intermedial layer 28 of the ducting or the thermally insulating material 27 inside the male coupling formation 10, 26 stretching from first length of ducting 3 to the second length of ducting 12, which is interrupted only by the relatively thin annular flange 29 of the male coupling formation 10 and the relatively thin annular flange 30 of the female coupling formation 10. Hence, these embodiments 1, 22 are likely to exhibit substantially better thermal performance as compared to the connections formed by the prior art method, which typically result in gaps of substantial lengths being formed between the in-duct insulation of two connected lengths of ducting. Additionally, the prior art connection method typically makes use of metal cylindrical duct joiners in the regions of these gaps and metal typically has a fairly high thermal conductivity. In comparison, the first coupling member 2 and the second coupling member 9 of the illustrated embodiments are each formed from a plastics material having a lower thermal conductivity.

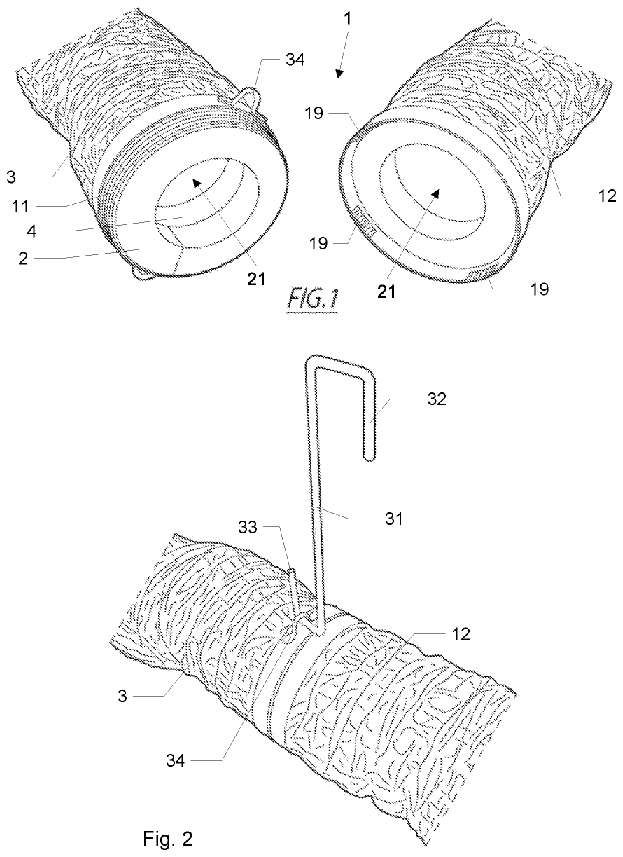

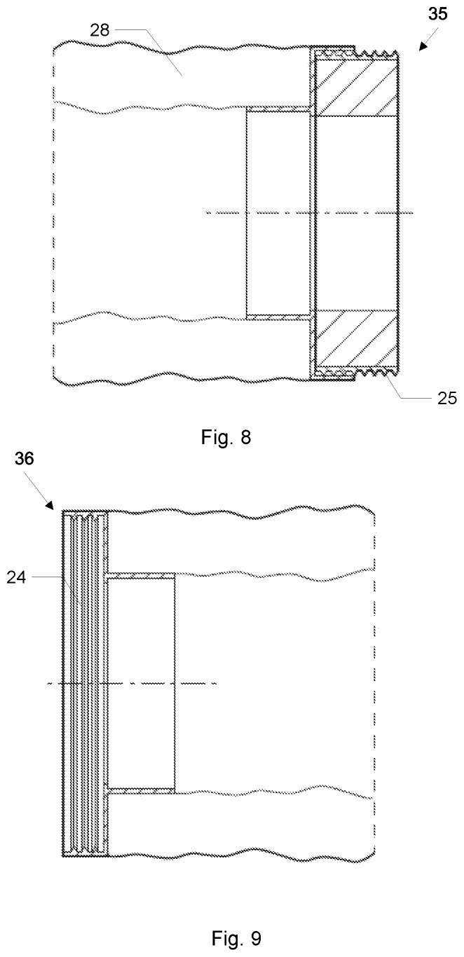

As shown in FIGS. 2 and 7, the duct coupling arrangement 1, 22 is configured to connect to a support bracket in the form of a generally S-shaped hook 31 having an upper end 32 that may be hung from a beam, such as a rafter or the like, inside a roof cavity. The lower end 33 of the hook 31 may be threaded through a connection fitting 34 that is disposed on a radially outer surface of the first coupling member 2. In alternative embodiments the connection fitting 34 may be disposed on a radially outer surface of the second coupling member 9. Either of these options provides a strong mounting point for the connection fitting 34.

In a typical embodiment, a single length of ducting has a first coupling member 2, 35 disposed at a first end of the ducting and a second coupling member 9, 36 at the opposite end. This allows like lengths of ducting to be readily coupled to each other so as to form an air-conditioning ducting system. Typically, various lengths of such ducting would be sold together as a kit, with the lengths being selected from a plurality of pre-defined lengths such as any two or more of: approximately 500 mm; approximately 1 m; approximately 2 m; approximately 3 m; approximately 4 m; approximately 5 m; and approximately 6 m. To save on packaging volume, the lengths of ducting are packageable in an axially compressed state.

The coupling arrangement 1, 22 described above may also be utilized on air conditioning units and for various air conditioning accessories and fittings. For example, in one embodiment the port on the air conditioning unit out of which the air conditioned air is pumped is fitted with a first coupling member 2, 35. This allows the installer to easily connect a length of ducting to the port of the air conditioning unit simply by coupling the second coupling member 9, 36 at one end of the ducting directly to the first coupling member 2, 35 of the port.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A duct coupling arrangement including:
a first coupling member being configured for axial connection to a length of ducting, the first coupling member defining a male coupling formation; and
a second coupling member being configured for axial connection to a length of ducting, the second coupling member defining a female coupling formation;
wherein the male coupling formation and the female coupling formation are configured to make an interference fit with each other so as to toollessly axially couple to and de-couple from each other.

2. A duct coupling arrangement according to claim 1 wherein the male coupling formation includes at least one circumferentially extending, radially outwardly projecting rib and wherein the female coupling formation includes at least one circumferentially extending, radially inwardly projecting rib and wherein an outer radius of the at least one outwardly projecting rib is slightly greater than an inner radius of the at least one inwardly projecting rib so as to provide said interference fit.

3. A duct coupling arrangement according to claim 1 wherein the male coupling formation includes at least one circumferentially extending, radially outwardly projecting rib and wherein the female coupling formation includes a plurality of resiliently deformable radially inwardly extending projections.

4. A duct coupling arrangement according to claim 1 wherein the female coupling formation includes at least one circumferentially extending, radially inwardly projecting rib and wherein the male coupling formation includes a plurality of resiliently deformable radially outwardly extending projections.

5. A duct coupling arrangement according to claim 3 wherein each of the projections has a radial height of between approximately 0.3 mm and 6 mm.

6. A duct coupling arrangement according to claim 2, wherein the at least one rib has a radial height of between approximately 0.3 mm and 6 mm.

7. A duct coupling arrangement according to claim 1 wherein the ducting includes an inner layer, wherein the first coupling member and the second coupling member each include an axially extending hollow cylindrical member sized to be received into said inner layer, and wherein an adhesive adheres the inner layer to the hollow cylindrical member.

8. (canceled)

9. A duct coupling arrangement according to claim 1 wherein the ducting includes an outer layer, wherein the first coupling member and the second coupling member each include an axially extending outer hollow cylindrical member sized to receive said outer layer, and wherein an adhesive adheres the outer layer to the outer hollow cylindrical member.

10. (canceled)

11. A duct coupling arrangement according to claim 1 wherein the female coupling formation includes a cylindrical member sized to receive the male coupling formation.

12. A duct coupling arrangement according claim 1 wherein the first coupling member and the second coupling member each include a central aperture positioned in axial alignment with an inner gas flow path defined by the ducting.

13. A duct coupling arrangement according to claim 1 wherein thermal insulation is disposed radially inwardly of the male coupling formation.

14. A duct coupling arrangement according to claim 1 wherein the first coupling member and the second coupling member are each formed from a plastics material.

15. A duct coupling arrangement according to claim 1 wherein the duct coupling arrangement is configured to connect to a support bracket.

16. A duct coupling arrangement according to claim 13 wherein a connection fitting is disposed on a radially outer surface of the first coupling member and/or the second coupling member, the connection fitting being configured to connect to a support bracket.

17. A duct coupling arrangement according to claim 1 wherein coupling of the first coupling member with the second coupling member forms a substantially air-tight seal.

18. A length of ducting extending between a first end and a second end, the length of ducting including:
a first coupling member being disposed at the first end, the first coupling member defining a male coupling formation configured to make an interference fit with a complementary female coupling formation of a like length of ducting so as to couple the length of ducting to the like ducting; and
a second coupling member being disposed at the second end, the second coupling member defining a female coupling formation configured to make an interference fit with a complementary male coupling formation of a like length of ducting so as to couple the length of ducting to the like ducting.

19. A length of ducting according to claim 18 wherein the length extending between the first end and the second end is selected from a plurality of pre-defined lengths.

20. A length of ducting according to claim 19 wherein the plurality of pre-defined lengths are any two or more of: approximately 500 mm; approximately 1 m; approximately 2 m; approximately 3 m; approximately 4 m; approximately 5 m; and approximately 6 m.

21. A length of ducting according to claim 18, wherein the length of ducting is packageable in an axially compressed state.

22. A method of installing air conditioning ducting including:
providing a plurality of lengths of ducting, each being in accordance with claim 18; and
coupling said lengths of ducting to each other so as to form an air-conditioning ducting system.
